(19) United States
(12) Patent Application Publication
(10) Pub. No.: US 2014/0131269 A1
(43) Pub. Date: May 15, 2014

(54) QUICK CONNECT MODULAR WATER PURIFICATION SYSTEM

(71) Applicants: William A. Greene, Long Beach, CA (US); Jason D. Gilmour, Huntington Beach, CA (US)

(72) Inventors: William A. Greene, Long Beach, CA (US); Jason D. Gilmour, Huntington Beach, CA (US)

(21) Appl. No.: 13/676,774

(22) Filed: Nov. 14, 2012

(51) Int. Cl. B01D 29/11

(52) U.S. Cl. CPC B01D 29/11
USPC 210/323.2

(57) ABSTRACT

In a water purifier module, feed water (impure water) moves through feed tubes (60, FIG. 3) that have feed tube holes (62) that open to a feed cavity (42). The feed cavity contains multiple filter fibers (36), and pure water (filtrate 44) flows into the filter fibers to an outlet. The filter fibers are closely packed to control the rates of fluid flow.

### CROSS-REFERENCE

This is a division of U.S. Ser. No. 12/753,485 filed Apr. 2, 2010 which claims priority from U.S. Provisional Patent Application Ser. No. 61/211,868 filed Apr. 2, 2009.

### BACKGROUND OF THE INVENTION

Salt water and other feed fluids can be purified by applying the feed fluid under pressure to the outside of a bundle of hollow filter fibers that are packed into a cavity. The pure water, commonly referred to as filtrate, passes through the fiber walls and along the fiber passages, to a filtrate outlet for use as drinking water. The fibers typically lie in an elongated cavity, such as a cylindrical cavity that is seven inches in diameter and 80 inches long with the feed water pumped into one end of the cavity and concentrate removed at the opposite end. The walls of the cavity constitute one of many modules that are used in a system to supply the required flow capacity of filtrate, such as drinking water for a ship.

The pressure of the feed fluid drops along the length of the fiber bundle. As a result, a high pressure of water may have to be applied to the inlet end, or upstream end, of the cavity to assure these is sufficient pressure at the downstream end. A system that required water at lower pressure would be advantageous in many situations.

In some cases, a purifying system of given capacity must be as compact as possible, as in the case of many ships. This requires modules that can be closely stacked.

### SUMMARY OF THE INVENTION

In accordance with one embodiment of the invention, multiple water purifier modules are stacked in a rack having manifolds for each of the various functions: feed, concentrate, and filtrate. Each module connects to the rack by a quick connect for each of the filtration tubes. The quick connects are of the self-sealing type. A handle on the end of the module away from the rack has a lever for causing the quick connects so release the module from the rack while the system remains in operation. The module can then be totally removed from the rack for testing, service, or replacement while the overall system remains in operation.

Each module of the system includes walls forming a cavity, and a bundle of hollow filter fibers that are closely packed in the cavity. Feed fluid, such as brackish or salty water, is fed under pressure to the cavity through one or more feed tubes. The feed tubes are of small diameter and extend primarily parallel to the length of the fibers, which extend along the length and axis of the cavity. Each feed tube has multiple small holes spaced along its length to distribute feed fluid more evenly along the length of the elongated cavity. Concentrate, which is fluid left after some filtrate has been removed from the feed fluid (by flowing filtrate into the hollow fibers), is received by one or more concentrate tubes.

The concentrate tubes each extends primarily along the length of the fibers, as do the feed tubes, and the concentrate tubes also have small holes spaced along their lengths. The feed tubes and concentrate tubes lie at opposite sides of the elongated cavity, to assure that feed fluid passes across multiple fibers in its passage between holes in the feed tubes and holes in the concentrate tubes.

The feed tubes and the concentrate tubes are each surrounded by fibers that are tightly packed together. This requires the feed fluid to pass closely across the outside surfaces of the fibers as the feed fluid flows towards the concentrate tube holes.

Each module has walls of primarily rectangular outside shape, and the cavity within the walls is of primarily rectangular shape. The rectangular shape allows multiple modules to be stacked closely together, so a system of given capacity occupies a minimum amount officer space. This is important in many applications, as in vessels used by the military.

The novel features of the invention are set forth with particularity in the appended claims. The invention will be best understood from the following description when read in conjunction with the accompanying drawings.

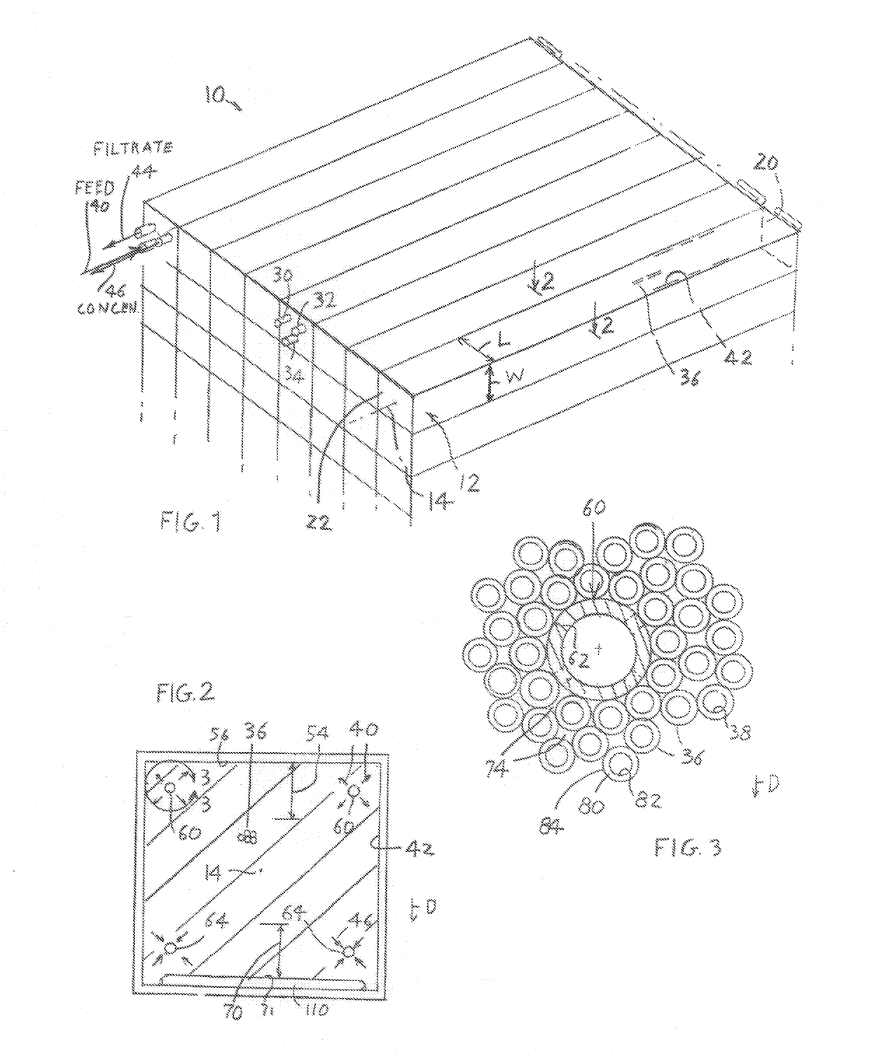

FIG. 1 is a partial isometric view of a filtration system of the present invention.

FIG. 2 is a sectional view of one module of the system of FIG. 1 taken on line 2-2 of FIG. 1.

FIG. 3 is an enlarged sectional view of a feed tube and of multiple fibers that surround it, of the area 3-3 of FIG. 2.

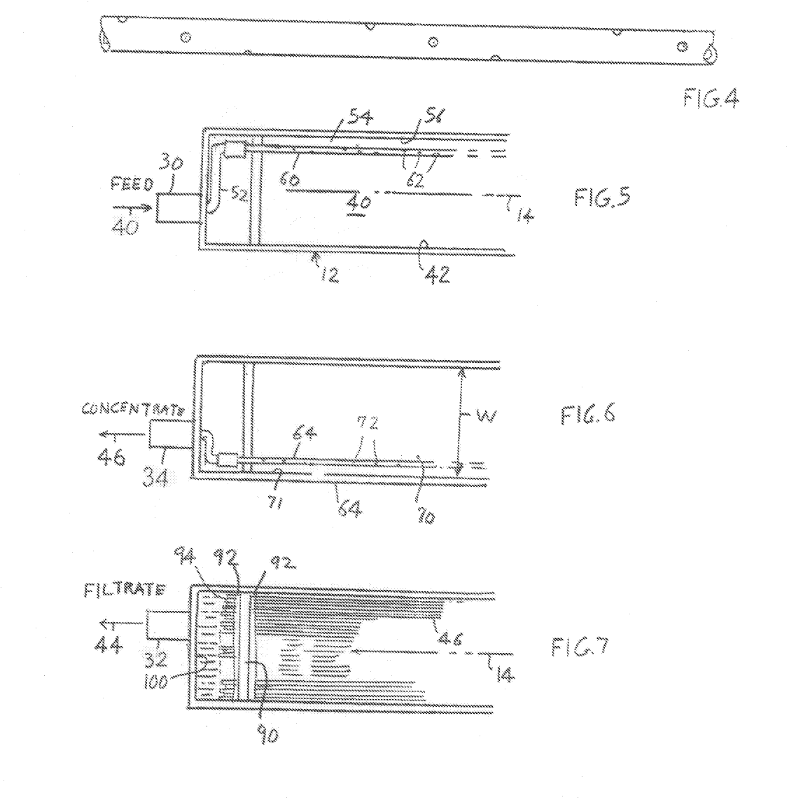

FIG. 4 is a side view of a portion of the feed tube of FIG. 3.

FIG. 5 is a partial sectional view of an end portion of the module of FIG. 2, showing only a feed tube thereof.

FIG. 6 is a view similar to that of FIG. 5, but showing only a concentrate tube thereof.

FIG. 7 is a view similar to that of FIG. 5, but showing only a filtrate outlet and a bundle of filter fibers.

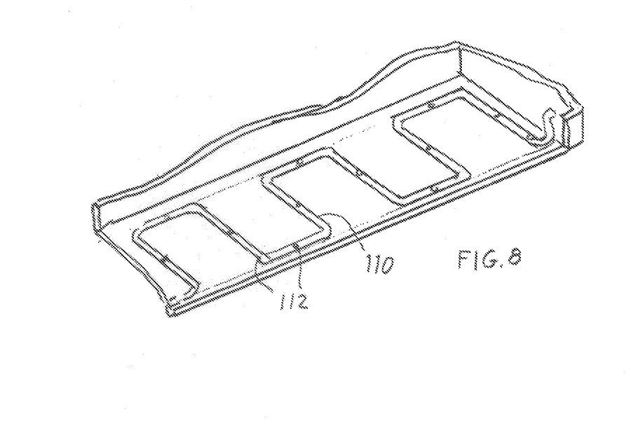

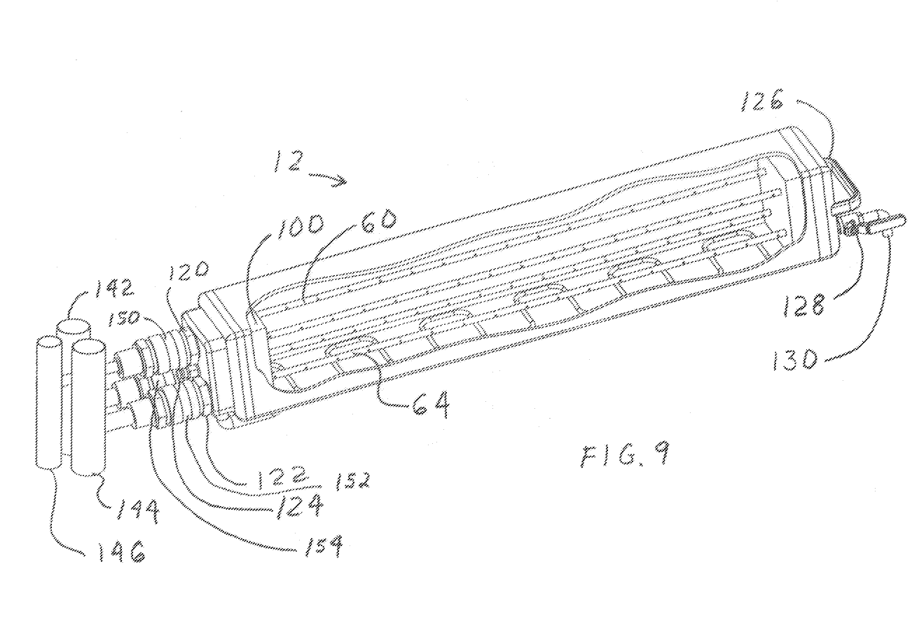

FIG. 8 is a partial isometric view of the module of FIG. 2, showing the air scrub tube.

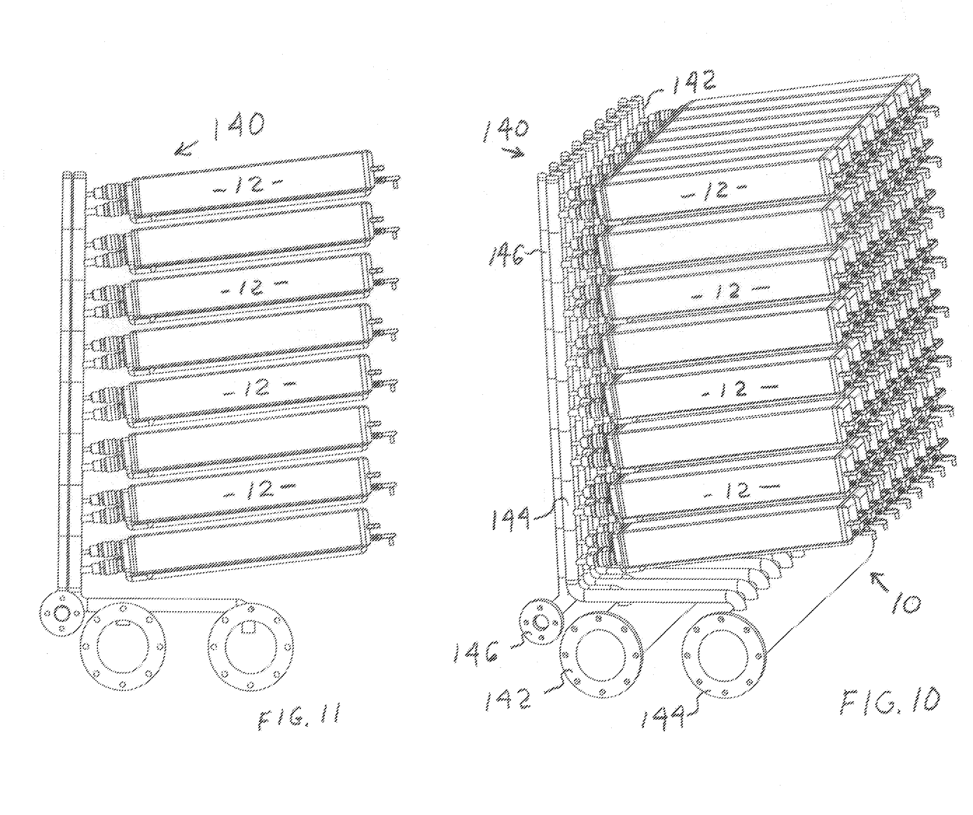

FIG. 9 is a perspective view of one module with the top and one side wall open to show the interior.

FIG. 10 is a perspective view of the module with the left end connected to rack manifolds by quick connects.

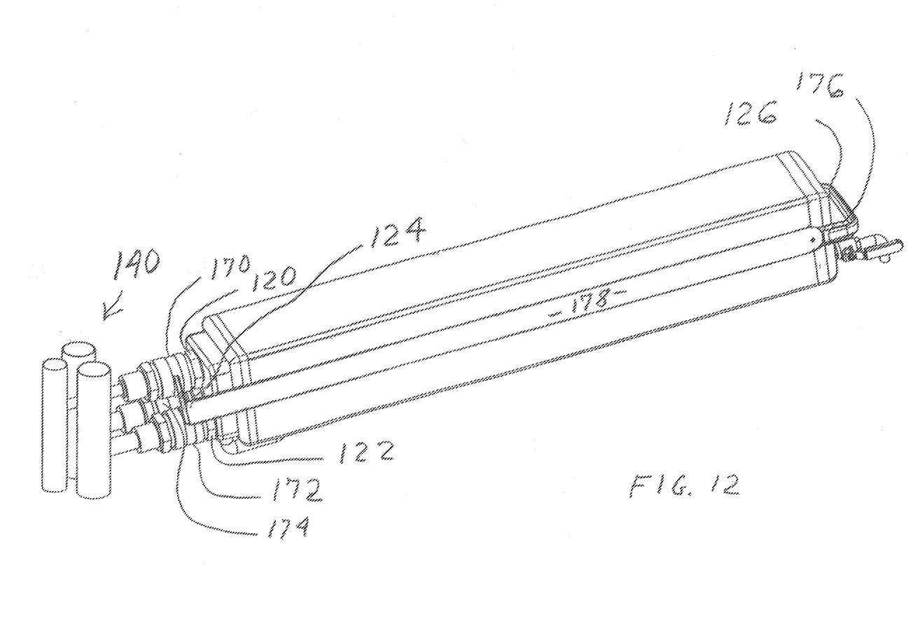

FIG. 11 is a side elevation view of the rack.

FIG. 12 is a perspective view of a module with a release mechanism.

### DESCRIPTION OF THE PREFERRED EMBODIMENTS

FIG. 1 shows a filtration system 10 of the invention, which includes many slacked modules 12. Each module is elongated along an axis 14, and is a plurality of times longer along its axis than along its width W or lateral length L. Each module has front and rear ends 20, 22. The rear end of each module has three ports including a feed port 30, a filtrate port 32 and a concentrate port 34. The module has additional ports that are not shown in the figure. As shown in FIG. 2, the module has a cavity 42 that is completely filled with hollow filter fibers 36 that extend along the axis 14. Feed fluid 40 (FIG. 1), such as brackish or salty water, is pumped through the feed port into the cavity 42 formed by the module, for purification. Filtrate 44, such as pure water (water with reduced solutes) exits the module through the filtrate port 32. Concentrate 46, which may include water that contains a higher concentration of solute such as salt than the original salt water, exits through the concentrate port. In the following description, applicant often uses the term “feed water” to mean “feed fluid” of any type that is to be purified, since the most common application of the invention is in purifying brackish or salty water.

FIG. 5 shows that feed fluid 40 is pumped under a pressure on the order of magnitude of 100 psi (7 bar) through the feed port 30 into the module. A conduit 52 carries the feed fluid to an upper side portion 54 (FIG. 2) of the cavity, which is closer to the top 56 of the cavity 42 than to the axis 14. The feed fluid passes along a small diameter feed tube 60 that extends along the upper side portion of the cavity, along the considerable length of the cavity. The feed tube has multiple small holes 62, and the feed fluid passes out of the holes 62 into the rest of the cavity. FIG. 2 shows that the particular system illustrated has two feed tubes 60 that each extends along the upper side portion 54 of the cavity. FIG. 2 also shows two concentrate tubes 64 that extend along the lower side portion 70 of the cavity.

FIG. 6 shows that each concentrate tube 64 extends along the cavity lower side portion near the lower side 71, along the considerable length of the cavity. Each concentrate tube has multiple small holes 72 spaced along the concentrate tube length. Feed fluid that has entered the cavity through one of the feed tube holes 62 must pass along a majority of the width W of the cavity before if reaches one of the concentrate tube holes 72 and can exit the cavity. In its path between the feed and concentrate tubes, the feed fluid passes along the outside of many hollow fibers.

FIG. 2 shows that the feed fluid 40 and fibers 36 fill the cavity. As shown in FIG. 3, the fibers are tightly packed in the cavity to leave only thin spaces 74 between them through which the feed fluid can pass in its primarily downward D path towards the concentrate tube. The system must be designed with care to assure that most, or a high portion of the pressure drop of the pressured feed fluid, occurs during the passage of fluid through the walls 80 of the fibers into the fiber passages 82. Also, the system must be designed so a considerable portion of the solvent (e.g. the fresh water of salt water feed fluid) has passed into the fibers before the feed fluid reaches the concentrate tube. A major portion of the energy used to operate the system is the energy required to pressurize the feed fluid to a high pressure (e.g. on the order of magnitude of 100 psi) before pumping it through the feed port into the cavity. If the feed fluid passes through the cavity and reaches the concentrate outlet before significant solvent (e.g. water of salt water) has passed into the fibers, then there will be little filtrate produced for a given amount of energy expended to pressurize the feed fluid.

Applicant helps assure that the feed fluid will pass slowly across the outer surfaces 84 of the fibers, by the fact that the fibers are tightly packed in the cavity and are tightly packed around the feed tube. The filter fibers are preferably individual tubes with parallel axes. As shown in FIG. 2, such tight packing results in a majority of the filter fibers contacting at least four other filter fibers. Such tight packing results in only narrow spaces through which the feed fluid can flow so the fluid moves slowly and remains in contact with the fiber outside surfaces for a considerable amount of time. Such slow movement of the feed fluid is also assured by placing the feed and concentrate tubes at opposite sides of the cavity. Fibers 36 surround each feed tube 60 by more than 180° and preferably by more than 270°.

Applicant assures that feed fluid will not flow too fast between the feed and concentrate tubes, in the event that there is more than the expected amount of space between some fibers. This is done by making the feed tube holes 62 (FIG. 3) small and preferably by also making the concentrate tube holes 72 small. The small tube holes result in a pressure drop on the order of magnitude of 0.5 psi (0.03 bar) in the passage of feed fluid through a feed hole 62 into the cavity. It the rate of feed fluid flow into the cavity is considerably above the desired rate, then the higher pressure drop across the feed tube hole will lower the rate of flow into the cavity. A similar phenomenon occurs at the concentrate tubs holes. Since feed fluid passes into the cavity at the numerous locations of the numerous feed tube holes, an increased flow between only one feed hole and a closest concentrate hole will result in only a moderate increase in feed fluid flow rate.

FIG. 6 shows that the concentrate tube 64 is connected to the concentrate port 42 in a manner similar to that for the feed tube. FIG. 7 shows that the fibers 46 are packed into a tight pack prior to insertion into the cavity. The fibers also have been extended through a wall 90, and end portions of the fibers have been sealed to walls of the cavity as by adhesive 92, without sealing the fiber passages. The tips 94 of the fibers open to a chamber 100 that leads to the filtrate port 40.

In a system that applicant has constructed, the fibers 36 (FIG. 3) each have an outside diameter of 1.5 millimeters and have a passage 38 of a diameter of 0.75 mm. Each of the two feed tubes 60 have an outside diameter of 6 mm, and each feed tube hole 62 has a diameter of 0.4 mm. There are ten feed tube holes, which are spaced apart by 8 mm. The use of small diameter feed tube holes has the additional advantage that they require only a small feed tube wall thickness. If the feed tube wall thickness had to be much greater because of the high fluid pressure and large feed tube wall thickness, then the feed tube would occupy more of the cavity cross section and thereby leave less room for fibers.

The system that applicant designed had modules having a width and lateral length that were each 6 inches (152 mm), and had an axial length along its axis of 40 inches (1020 mm). Each cavity has a cross-section of about 5.5 inches by 5.5 inches, or about 30 inch² (19,000 mm²). Each feed tube 60 had an outside diameter of 6 mm for a cross-section of 36 mm². Thus, the two feed tubes occupied only about 0.4% of the cross-section of the cavity. It is desirable that the feed tubes occupy no more than 2% of the cross-section, and preferably no more than 1% thereof.

At intervals of about 12 hours during heavy use of the system, it is desirable to apply an air scrub. During an air scrub, air is released into the cavity and is removed through the feed tube holes. The air scrub helps remove particles from the pores at the outside of the fibers, to allow more filtrate to penetrate the fibers. FIGS. 2 and 8 shows that applicant provides an air tube 110 with holes 112, that extends through the length of the cavity. The air tube lies below the fibers, and possibly in a chamber that is separated by a screen from the pack of fibers. The air tube extends in a serpentine path along the module length to apply air throughout the cavity.

FIG. 9 is a perspective view of one module 12 with the top and one side wall open to show the interior. On the left end are male quick connect plugs 120, 122, and 124 that are connected to feed tube 60, concentrate tube 54, and filtrate in chamber 100, respectively. On the right end is a handle 126 for manipulating the module. A valve 128 and spigot 130 allow the condition of the module to be tested.

FIG. 10 is a perspective view of sixty-four of the modules 12 plugged into a rack 140 having manifolds for each function: feed manifold 142, concentrate manifold 144, end filtrate manifold 146. This created the overall filtration system 10 having eight rows and eight columns. In the system that applicant designed, fluid in the form of sea water (salt concentration of 3.5%) was designed to flow through the system of sixty-four modules at a rate of about 8 gallons per minute.

FIG. 9 shows how one module 12 connects to the rack manifolds 142, 144 and 146 by self sealing quick connects 150, 152, and 154. These are typical liquid quick connects with the female quick connect sockets on the rack 140 (FIG. 10) and the male quick connect plugs 120, 122, 124 on the module 12. The female portions are self-sealing. That is, they allow fluid to pass only when the male portion is inserted in the female portion. When the male plugs are removed as happens when a module 12 is removed from the rack 140, the female sockets immediately close preventing fluid in the manifolds from squirting out or air from being sucked in the system.

FIG. 11 is a side elevation view of the rack 140. Each module 12 is entirely supported on the rack by the quick connects.

FIG. 12 is a perspective view of a module 12 with a release mechanism. When a module is to be removed for servicing, the collars 170, 172, and 174 must be pushed back on the sockets to release the male plugs 120, 122, and 124 from the female sockets. This is done by gripping the handle 126 and squeezing a lever 176 underneath. This pushes a slide 178 along the side of the module which pushes on the quick connect collars 170, 172, 174 to release the mate plugs 120, 122, and 124 from the sockets. This releases the module 12 from the rack 140.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. A fluid treatment system for receiving pressured feed fluid at a feed input port (30), for flowing the feed fluid into a feed cavity (42) that has an axis (14) and that contains multiple elongated individual hollow filter fibers (36) that each has a passage (38) extending along its length and along said axis, with said filter fibers being tightly packed to lie against one another, for flowing feed fluid through walls of said hollow filter fibers to flow filtrate into the passages (38) of the fibers and out of the system, and for flowing concentrate (46) that lies in the feed cavity and around the fibers into a concentrate outlet (34), wherein:
said system includes at least one feed tube (60) that is connected to said feed input port to receive said pressured feed fluid, said feed tube having a plurality of feed tube holes (62) opening to said feed cavity (42) to allow said feed fluid to flow around said filter fibers so filtrate can flow into said fibers;
said filter fiber (36) are tightly packed together and are tightly packed around said feed tube, so a majority of said filter fibers contact at least four other filter fibers.

2. The system described in claim 1 wherein:
said system includes at least one concentrate tube (64) which has a plurality of holes (72) and which has a tube passage that leads to said concentrate outlet (34);
said cavity is elongated along said axis (14), and said cavity has side portions (54, 70) spaced in a direction perpendicular to said cavity axes (64);
said feed tube and concentrate tube lie in said opposite Side portions (54, 70) of said cavity.

3. The system described in claim 1 wherein said system includes a housing with walls forming said feed water cavity, and said multiple filter fibers form a pack having a predetermined cross-section, and wherein:
said at least one feed tube (60) has a cross-sectional area of no more than 2% of the cross-sectional area of said multiple filter fibers.

4. A fluid treatment system for receiving pressured feed fluid at a feed input port (30), for flowing the feed fluid into a feed cavity (42) that has an axis (14) and that contains multiple elongated individual hollow filter fibers (36) that each has a passage (38) extending along its length with said filter fibers being tightly packed to lie against one another and that extend parallel to said axis, for flowing feed fluid through walls of said hollow filter fibers to flow filtrate into the passages (38) of the fibers and out of the system, and for flowing concentrate (46) that lies in the feed cavity and around the fibers into a concentrate outlet (34), wherein:
said system includes at least one feed tube (60) that extends parallel to said axis (14) and that is connected to said feed input port to receive said pressured feed fluid, said feed tube having a plurality of feed tube holes (62) opening to said feed cavity (42) to allow said feed fluid to flow around said filter fibers so filtrate can flow into said fibers;
said feed tube is closely surrounded by multiple ones of said filter fibers, and:
the size and number of said feed tube holes, is chosen for the system so there is a pressure drop on the order of magnitude of one-half psi between the pressure of feed fluid in said at least one feed tube (60) and the pressure of feed fluid in said feed cavity (42).

5. The system described in claim 4 wherein:
said filter fibers are in the form of individual tubes wherein said tubes extend parallel to each other and said tubes are packed close enough to each other that a majority of said tubes contacts at least four other of said tubes.
